(19) United States
(12) Patent Application Publication
(10) Pub. No.: US 2026/0228220 A1
(43) Pub. Date: Aug. 6, 2026

(54) LOGICAL IMPLICATION STEERING

(71) Applicant: Salesforce, Inc., San Francisco, CA (US)

(72) Inventor: Damjan Kalajdzievski, Palo Alto, CA (US)

(73) Assignee: Salesforce, Inc., San Francisco, CA (US)

(21) Appl. No.: 19/070,555

(22) Filed: Mar. 5, 2025

Related U.S. Application Data
(60) Provisional application No. 63/752,608, filed on Jan. 31, 2025.

(51) Int. Cl. G06F 16/2455; G06F 16/25

(52) U.S. Cl. CPC G06F 16/2455; G06F 16/258

(57) ABSTRACT

Logical implication steering in a machine learning model. In some implementations, a machine learning model with a logical implication circuit installed receives a text-based version of a prompt. The text-based version of the prompt is tokenized in an input embedding layer of the machine learning model to generate a token-based version of the prompt. From the token-based version of the prompt, a token-based version of a response is generated. This generation includes iteratively predictively selecting tokens for the token-based version of the response. The iteratively predictively selecting tokens comprises applying the logical implication circuit that, when a first vector is similar to a representation on an input to a linear mapping operation in the machine learning model, steers the generating toward a second vector. The token-based version of the response is converted to a text-based version of the response and output by the machine learning model.

### CROSS-REFERENCE TO RELATED APPLICATIONS

This application claims the benefit of U.S. Provisional Application No. 63/752,608, filed Jan. 31, 2025, which is hereby incorporated by reference.

### TECHNICAL FIELD

One or more implementations relate to the field of machine learning models; and more specifically, to the logical implication steering in machine learning models.

### DESCRIPTION OF THE RELATED ART

The field of Artificial Intelligence (AI) focuses on the implementation of artificial neural network systems that aim to mimic the functionality of neurons in the brain. Machine learning is a sub-area of AI in which a machine learning model is trained to perform one or more specific tasks. For instance, a machine learning model can be trained to perform a target task by relying on patterns and inferences learned from training data, without requiring explicit instructions pertaining to how the task is to be performed.

Large language models (LLMs) are neural networks trained to mimic human language. Specifically, LLMs are trained to predict a next token of a block of text. In operation, LLMs track relationships in sequential data by receiving tokens (e.g., words in a sentence) and predicting a next token (or sequence of tokens). Accordingly, LLMs are well suited to form conversations (e.g., taking turns asking questions and providing responses) by predicting tokens (or sequences of tokens) that are tailored to the style and context of the conversation.

LLMs are trained on billions of tokens mainly extracted from the Internet. The combination of such a vast data landscape and their inherent architecture provides an incredibly powerful general knowledge generator. However, in most practical cases, there is a need for highly specialized LLMs. This allows one to apply the reasoning and generalization properties of LLMs to a particular sub-domain/task.

Training a model from scratch requires both specialized knowledge of the particular LLM being trained as well as access to a significant quantity of general-purpose training data as well as training data that is relevant to the sub-domain/task for which the LLM is being trained. This makes such training outside of the skillset of a typical user.

Fine-tuning is a technique where a pre-trained AI model (e.g., an LLM) is further trained on a smaller, domain-specific data set, allowing the model to adapt to the specific language and context of the domain. This improves its performance on domain-specific tasks (e.g., medical, legal, financial, or technical texts where language usage significantly differs from general language data; “Brand Voice” refers to the unique style, tone, and language used by a brand in its communications; etc.). Examples of pre-trained AI models include BERT (e.g., ROBERTa, AraBERT, VisualBert, M-BERT, etc.), GPT (e.g., GPT-3, GPT-4, GPT-4V, etc.), T5 (e.g., Large, 3B, 11B, etc.), Mistral (e.g., Mistral 7B, Mistral Large, etc.), XLM-R, CLIP, DALL-E (e.g., DALL-E 2, DALL-E 3, etc.), Gemini (e.g., Gemini 1.0 Ultra, Gemini 1.5, etc.), Claude (e.g., Claude 2, Claude 3, etc.), Cohere (e.g. Command), LLaMa (e.g., LLaMa 2, LLaMa 3, etc.), etc.

There are various architectures used in machine learning models. One type of architecture is referred to as transformer-based LLMs. A typical transformer-based LLM includes an input embedding layer, a plurality of blocks (sometimes referred to as transformer blocks) in an order, and an output embedding layer. Most, if not all, of the plurality of blocks each include an attention layer (sometime referred to as an attention block) and a multi-layer perceptron (MLP) (sometime referred to as a feed-forward network, feed-forward network block, neural network, neural network block, etc.). A given attention layer may be implemented a variety of ways, including the use of self-attention, cross attention, multiple attention heads (sometimes referred to as multi-head attention, multi-head latent attention (MLA)), etc. Typical transformer-based LLMs include additional layers outside and/or within the transformer blocks (e.g., such as normalization layer(s)).

A common operation within a typical transformer-based LLM (e.g., within a transformer block, within an attention layer, etc.) is a linear mapping operation. Linear mapping is a mathematical operation that transforms (which may be, additive, multiplicative, etc.) a set of input values into a set of output values using a linear function. A typical linear mapping operation may be represented as y=Wx+b, where x is the input vector, W is the weight matrix, b is the bias vector, and y is the output vector. One type of linear mapping is referred to as a linear projection, which maps a vector space onto a sub-space.

### BRIEF DESCRIPTION OF THE DRAWINGS

The following figures use like reference numbers to refer to like elements. Although the following figures depict various example implementations, alternative implementations are within the spirit and scope of the appended claims. In the drawings:

FIG. 1 is a block diagram illustrating a machine learning model that implements logical implication steering according to some implementations.

FIG. 2 is a block diagram illustrating logical implication steering in conjunction with a linear mapping operation in an attention layer according to some implementations.

FIG. 3 is a flow diagram illustrating the generating and installing a logical implication circuit in a machine learning model according to some implementations.

FIG. 4A is a flow diagram illustrating the use of a logical implication circuit installed within a machine learning model according to some implementations.

FIG. 4B is a flow diagram illustrating the above described first way according to some implementations.

FIG. 4C is a flow diagram illustrating the above described second way according to some implementations.

FIG. 5A is a block diagram illustrating an electronic device according to some example implementations.

FIG. 5B is a block diagram of a deployment environment according to some example implementations.

### DETAILED DESCRIPTION

The following description describes implementations of logical implication steering (LIMS) in machine learning models. For example, the responses generated by a machine learning model (the machine learning model's generation behavior or generative behavior) can be steered toward a given concept by adding the concept's vector to the corresponding activations in the machine learning model. In some implementations, LIMS enable transparent and interpretable adjustments that induce a chosen generative behavior in response to the presence of any given concept. In some implementations, this allows for the integrating neuro-symbolic logic into pre-trained transformer models. Thus, some implementations of LIMS provide for conditional interventions on transformer-based machine learning model generation. This sort of steering is desirable to control the output of machine learning models (e.g., LLMs) for a variety of reasons, such as aligning the output with human values, ethical standards, specific domains, specific styles, etc. Training an entire machine learning model from the ground up or fine tuning a pretrained machine learning model requires significant computational resources. Implementations described herein offer more precise control using less computation resources. During inference, this control can be used to reduce toxicity, control sentiment, adjust linguistic style, etc.

While logical implication steering may be implemented in different location and in different ways, in some implementations logical implication steering is applied in or around an existing linear mapping operation in a pre-trained machine language model. In some implementations of the logical implication steering described herein, the training can be performed using a relatively small number (e.g., 7 to 500; in some cases, between 10 and 100; in some cases, between 80 and 120; in some cases, at or around 100; in some cases, it is little as one for each set (P, not P, Q, not Q)) of data points and some or all of this training may be done externally to the machine learning model.

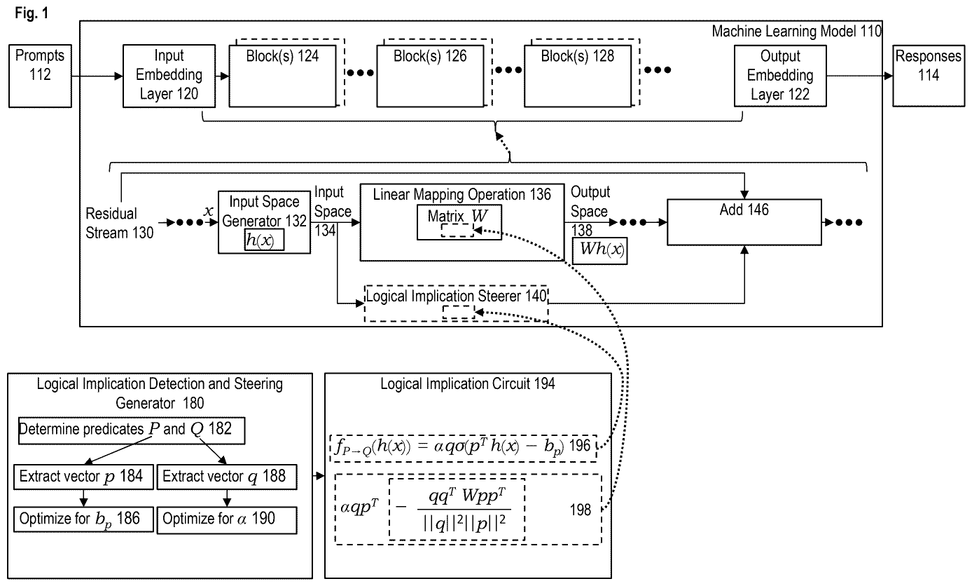

FIG. 1 is a block diagram illustrating a machine learning model 110 that implements logical implication steering according to some implementations. The machine learning model 110 receives prompts 112 and generates respective responses 114. While the machine learning model 110 is shown as including an input embedding layer 120, a number of blocks in an order (block(s) 124 . . . block(s) 126 and . . . blocks(s) 128), and an output embedding layer, implementations may include more, less, and/or different layers and blocks.

In some implementations, prompts 112 represent text-based versions of prompts, and the input embedding layer 120 tokenizes those text-based versions of the prompts to generate token-based versions of the prompts. Responsive to a token-based version of a prompt, the machine learning model 110 generates a respective token-based version of a response. The output embedding layer 122 converts the token-based version of the response to a text-based version of the response. The machine learning model 110 outputs the generated responses 114.

The generation of a token-based version of a response from a token-based version of a prompt is performed in an iterative fashion, often by predictively selecting a next token of the token-based version of the response at a time. Further, rather than buffering the response (at the token level or text level) for outputting once the response is complete, implementations often convert the predictively selected tokens and output the text as the selections are being made. The predictively selecting is performed responsive to the tokens being processed through a number of blocks, which are illustrated as including block(s) 124 . . . block(s) 126 . . . blocks(s) 128, in an order. As previously described, in the case of a transformer-based LLM: 1) the blocks (block(s) 124 . . . block(s) 126 and . . . blocks(s) 128) may be referred to as transformer blocks and each include an attention layer and an MLP; and 2) typically includes additional layers outside and/or within the transformer blocks (e.g., such as normalization layer(s)).

As previously described, a common operation within a typical transformer-based LLM (e.g., within a transformer block, within an attention layer, etc.) is a linear mapping operation. FIG. 1 illustrates a linear mapping operation 136 performed at some location in machine learning model 110 (illustrated by a dotted line connecting a lower bracket with an upper bracket spanning from the input embedding layer 120 to the output embedding layer 122. A residual stream 130 provides a sequence x to an input space generator 132 which performs operation h to produce h(x) as an input (input space 134) for linear mapping operation 136. Linear mapping operation 136 transforms, based on a matrix W (and often a bias), the input to an output (output space 138) shown as Wh(x). After zero or more additional operations on the output, the output is combined with the residual stream 130 (represented by add 146).

FIG. 1 illustrates the applying of logical implication steering that, when a first vector is similar to a representation on an input to the linear mapping operation 136 in the machine learning model 110, steers the generative behavior toward a second vector. In some embodiments, the similarity of the first vector to a representation on the input is measured using doc-product similarity. FIG. 1 illustrates exemplary ways of implementing logical implication steering within machine learning model 110: 1) through a logical implication steerer 140 added around the linear mapping operation 136 (referred to as the first way); and/or 2) through a modification of the parameters of the matrix W of the linear mapping operation 136 (referred to as the second way).

According to the first way (in which logical implication steerer 140 has been added around the linear mapping operation 136): a) the linear mapping operation 136 will be performed on the input and the matrix W to generate a first output; b) the logical implication steerer 140 (e.g., implemented as a feed forward network) calculates a second output based on the input to produce a second output; and c) the first output, second output, and the residual stream 130 are combined at add 146. Logical implication steerer 140 (e.g., implemented as a feed forward network) was trained to produce outputs that steer toward the second vector only when the first vector is similar to a representation on inputs to the feed forward network.

According to the second way (that involves a modification of the matrix W of the linear mapping operation 136), the matrix was modified to cause the output to steer toward the second vector based on a magnitude of similarly of the first vector and the representation on the input to the linear mapping operation 136.

While the first way described above introduces logical implication steering with a nonlinear mapping implemented with a architecture change to the machine learning model, the second way can be viewed as a “mergeable” variant (m-LIMS) that facilitates deployment by merging into existing parameters with no architecture changes to the machine learning model being required. The m-LIMS variant performs just as well as LIMS, at the cost of a relatively small reduction in interpretability. Logical implication steering may be implemented in conjunction with one or multiple linear mapping operations, and each such implementation may be one, the other, or both of the two ways described above.

FIG. 1 illustrates a logical implication detection and steering generator 180 to generate a logical implication circuit 194. Exemplary equations for the above described first and second ways are respectively shown as f_{P→Q}(h(x))=αqσ(p^{T} h(x)−bₚ) 196 and αqp^{T} 198 (which may optionally include a subtraction of a value to from αqp^{T}−(qq^{T} Wpp^{T})/(∥a∥²∥p|²)). FIG. 1 illustrates with logical implication detection and steering generator 180 the follow operations to determine values to use in these equations, including: 1) determining predicates P and Q 182; 2) extracting vector p 184 (the first vector) from predicate P; 3) optimizing for bₚ 186 based on the first vector; 4) extracting vector q 188 (the second vector) from predicate Q; and 5) optimizing for a 190 based on the second vector (where a is used to scale the second vector, and in some implemented is an optimized hyperparameter).

The logical implication circuit 194 is installed in machine learning model 110, which is illustrated with a dotted line from 196 into logical implication steerer 140 (e.g., representing the loading of weights from a feed forward network trained outside of machine learning model 110 into logical implication steerer 140) and a dotted line from 198 to matrix W (e.g., representing modifying weights/parameters of matrix W based on 198). These equations will be described in greater detail below. Also, as will be described later herein, while some of implementations perform operations 186 and 190 prior to installing logical implication circuit 194, other implementation perform operations 186 and 190 (and thus, use machine learning model 110 to optimize for bₚ and/or α).

In some implementations, the logical implication steering is conditional. That is, only when the first vector (vector p) is detected (similar to a representation on the input), is the residual stream steered away from the first vector and toward the second vector (vector q). In terms of the predicates, when the predicate P is approximately present in an input to the linear mapping operations, the generative behavior is performed consistent with predicate Q.

Thus, implementations allow for general neuro-symbolic logic to be implemented in machine learning models in an interpretable and algorithmic way. More specifically, a logical implication circuit installed into a pre-trained transformer-based machine learning model approximately obeys the logic: “If concept P is present in an input x, behave according to generation behavior consistent with the concept Q.” This may be referred to as “If P (x) then Q(x)” or “P→Q”. As an example, the concept P may be a user requesting for the model to behave in a harmful or toxic way, and Q could be the generation behavior rejecting such a request. Thus, implementations unify neuro-symbolic logic into the representations of pre-trained generative transformer-based machine language models. In some implementations, a contrastive approach is used to distinguish when concepts and behaviors are present or not, and extracts the “P”-condition and “Q”-behavior as concept vectors p, q such that, when using the above-described first way, a feed-forward circuit may be added to steer with q only when sensing p. As opposed to a traditionally opaque fine-tuning or prompting process, the resulting circuit provides an interpretable and disentangled function/operation, promoting transparency and precision with a separation between model classification accuracy of P and controlled behavior adjustments into Q.

The interpretability of the logical implication circuit is beneficial because it allows for the relative difficulties of classification and steering on a given task to be observed and/or the use of relatively simple statistical models on the decoupled sensing and steering components to estimate model generalization from classification. Implementations of logical implication steering in a machine learning model may be used to detect and reduce hallucinations, increase model safety, and/or increase reasoning when required to solve math problems. Advantageously, relatively meaningful improvement can be achieved based on a relatively low data regime of training data points, including on the difficult problem of reducing hallucinations caused by insufficient information in context; in contrast, traditional fine-tuning typically requires at least 10 times more training data points to be as effective. By way of specific examples, logical implication steering may be used for: 1) detecting and flagging hallucinations; 2) reducing hallucinated responses by addressing unanswerable questions; 3) improving reasoning through automatic chain-of-though trajectories in math problems; and/or 4) rejecting harmful or toxic instructions in adversarial prompts. In addition, the described logical implication steering does not need to be learned with backpropagation of gradients through the machine learning model; rather, the process may be performed using the lower amounts of memory and compute used for model inference, allowing for the use of fewer resources to “train” logical implication steering circuits into much larger models than model fine-tuning.

According to some implementations, pseudo-code for LIMS is shown in equation 1. In particular, a probabilistic neuro-symbolic logic is defined that is intended to capture concepts, and leverage their use with concept vectors which are hypothesized to exist by the linear representation hypothesis. Supposing some implicit distribution on the input space, define the set of “concept-predicates” [symbol] relative to a model Y, as the set of all predicates that are causally independent with respect to the model output, and sufficient to fully prescribe model output from the input.

Definition 3.1. Given a model Y on some input probability space, a set of concept-predicates [symbol] is any maximal set of predicates (boolean-valued random variables) satisfying:

### 1. Concept Predicates are Disentangled and Causally Independent:

$$∀ {P}_{0 , … ,} {P}_{n} ∈ \text{?} ,$$

$$Pr ( {P}_{0} ( X ) , … , {P}_{n} ( X ) \vert Y ( X ) , X ) = Pr ( {P}_{0} ( X ) \vert Y ( X ) , X ) \cdot … \cdot Pr ( {P}_{n} ( X ) \vert Y ( X ) , X ) . \qquad ( 1 )$$

### 2. Concept Predicates Cover Specifications for Outputs:

$$∀ x ∃ {P}_{0} , … , {P}_{n} ∈ {\text{?}}_{Y} , \qquad ( 2 )$$

$$Pr ( Y ( X ) \vert X = x ) = Pr ( Y ( X ) \vert {P}_{0} ( x ) , … , {P}_{n} ( x ) ) .$$

This aligns with the intuition that a model's behavior and perception of an input can be decomposed into a set of fundamental, disentangled attributes, each influencing the output in a distinct way. Formally, concept predicates P_{Y} are defined relative to a model Y, but since the context usually makes this clear, the subscript will be omitted unless clarification is needed.

In this formalism, the linear representation hypothesis is defined as the statement that any concept-predicate P can be approximately defined by a single vector in the space of representations, to arbitrary precision.

Definition 3.2. The linear representation hypothesis for a model is the statement that for any concept predicate P there is some section of the hidden representation h(x) in [symbol] ⁿ such that for all ε, δ∈ [symbol] ⁺ there are p∈ [symbol] ⁿ, bₚ∈ [symbol] that satisfy:

$$Pr ( \vert P ( X ) - σ ( {p}^{T} h ( X ) - {b}_{p} ) \vert > δ ) < ε , \qquad ( 3 )$$

where σ is the Heaviside function. We refer to p as a (sensing) concept vector for P, and we call the linear perceptron:

$${f}_{p} ( x ) = σ ( {p}^{T} h ( X ) - {b}_{p} ) \qquad ( 4 )$$

a sensing circuit for P.

We note that the purpose of steering vectors sₚ for some concept P is to bring the hidden state of the model close to the concept vector p of a later layer's space via addition:

$$1 \approx σ ( {p}^{T} LayerNorm ( h ( x ) + {s}_{p} ) - {b}_{p} ) . \qquad ( 5 )$$

This functional form defining concepts in terms of vectors allows for building the desired logic into the model.

Please note that negation and implication are complete for propositional logic, and so any quantifier free formula can be implemented with a combination of those logical operators. Since LIMS can also implement the feedforward circuit P(x)→¬P(x), LIMS can theoretically be composed to enact any quantifier free formula in this concept-predicate logic.

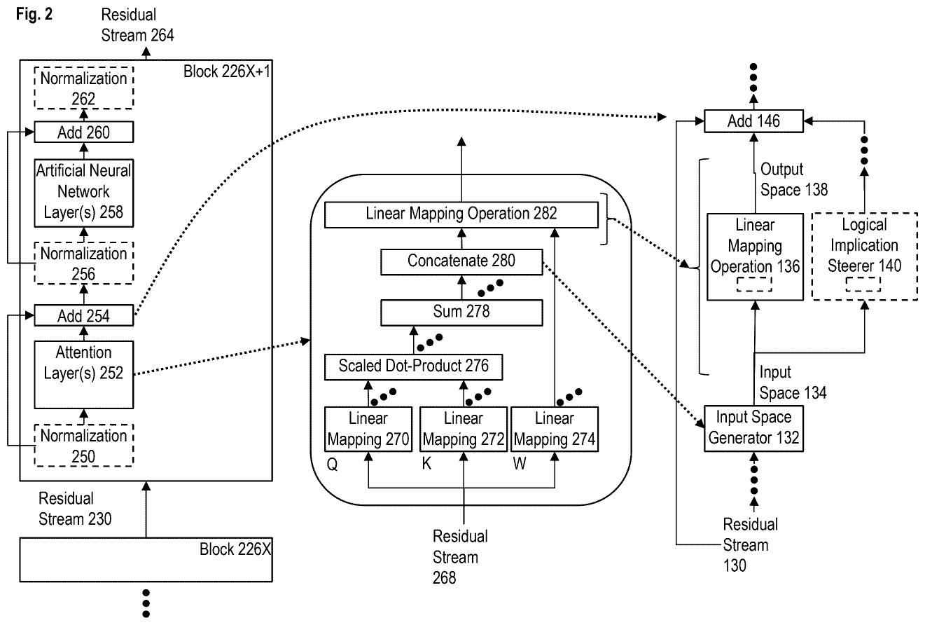

FIG. 2 is a block diagram illustrating logical implication steering in conjunction with a linear mapping operation in an attention layer according to some implementations. FIG. 2 shows a block 226X followed by a block 226X+1, which represents two of the blocks (block(s) 124 . . . block(s) 126 . . . blocks(s) 128) in an order. A residual stream 230 is output from block 226X and provided as an input to block 226X+1, which in turn outputs residual stream 264. Block 226X+1 is illustrated as a transformer-based block that includes: 1) optional normalization layer 250; 2) attention layer(s) 252; 3) add 254; 4) optional normalization layer 256; 5) artificial neural network layer(s) 258 (also referred to as a feed-forward network or an MLP); 6) add 260; and 7) optional normalization 262. Also, FIG. 2 illustrates with a dotted line an implementation in which the attention layer(s) 252 implements multi-head attention. While there are various ways to illustrate and implement multi-head attention, FIG. 2 provides one conceptual illustration by way of example and not limitation. FIG. 2 shows an attention head that is provided a residual stream 268 as an input to linear mapping operation 270, linear mapping operation 272, and linear mapping operation 274 which respectively operate using matrices represented with Q, K, and W. The outputs of the linear mapping operation 270 and linear mapping operation 272 are provided to scaled dot-product 276, which output is provided to sum 278. The “ . . . ” illustrates that there are other attention heads. The outputs of the attention heads are provided to concatenate 280, which provides an input to linear mapping operation 282. Typically, linear mapping operation 282 performs a linear projection on the input using a matrix that is sometimes referred to as the output matrix, attention output projection map, output attention projection matrix, or similar name).

FIG. 2 reproduces residual stream 130, input space generator 132, linear mapping operation 136, logical implication steerer 140, and add 146. In addition, dotted lines illustrate that: 1) concatenate 280 may operate as input space generator 132; 2) linear mapping operation 282 may operate as linear mapping operation 136; and 3) add 254 may operate as add 146.

Within an attention layer, different concepts reside on different dimensions in the large multi-dimensional space. In this case, the first vector (vector p) is a first concept vector (e.g., a concept that is outside of the domain the model is designed to answer), while the second vector (vector q) is a second concept vector (e.g., one within the domain or causes some form of an “I don't know” response to avoid hallucination). The logical implication steering is conditional. That is, only when the first concept vector is detected (similar to a representation on the input), is the residual stream steered away from the first concept vector and toward the second concept vector.

The method of claim 2, wherein the attention layer is part of a first of a plurality of blocks of the machine learning model, wherein the plurality of blocks is between the input embedding layer and the output embedding layer.

In some embodiments, the blocks (e.g., block(s) 124 . . . block(s) 126 . . . blocks(s) 128) are in an order, and wherein at least one quarter of the blocks come before block 226X+1. In other words, if there are X (e.g., 32) transformer blocks, the logical implication steering is performed in conjunction with a logical mapping operation within block(s) at a position in the order that is greater than or equal to X/4 (e.g., block 8, block 9, block 10, block 11, . . . block 32, or some combination thereof).

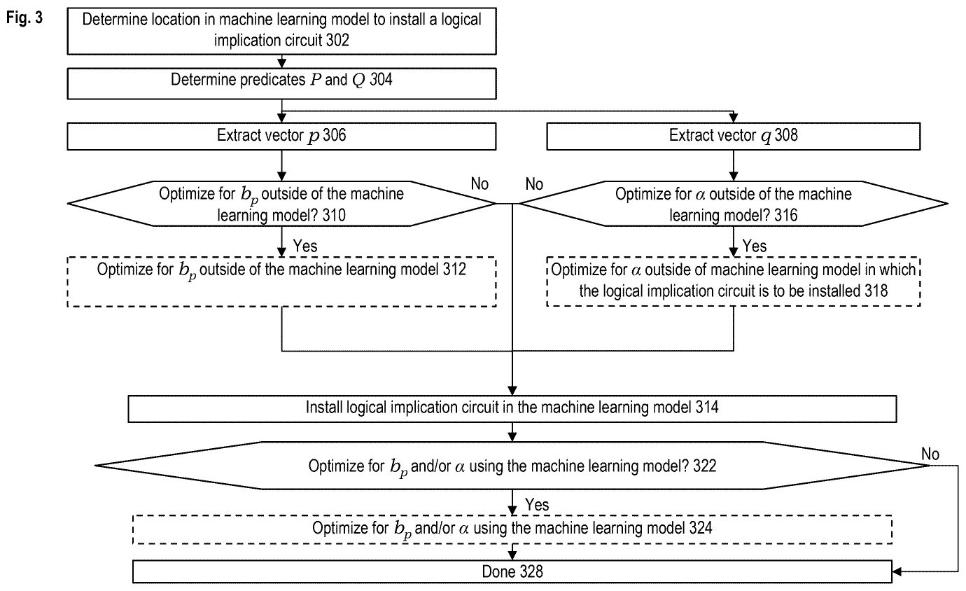

FIG. 3 is a flow diagram illustrating the generating and installing a logical implication circuit in a machine learning model according to some implementations. The process begins with determining the location in the machine learning model at which to install logical implication circuit 302. As described above, logical implication steering may be implemented in conjunction with one or more linear mapping operations in machine learning model 110, including one in an attention layer (see FIG. 2). At block 304, predicates P and Q are determined. In parallel or in any order, blocks 306 and 308 respectively illustrate extracting vector p and vector q. Control passes from block 306 to 310, and from block 308 to block 316.

In block 310, it is determined whether to optimize for bₚ outside of the machine learning model. If not, control passes to block 314; otherwise, control passes to block 312 in which a system is used to optimize for bₚ outside of the machine learning model. Similarly, in block 316, it is determined whether to optimize for a outside of the machine learning model. If not, control passes to block 314; otherwise, control passes to block 318 in which a system is used to optimize for a outside of the machine learning model. If implemented, control passes from both blocks 312 and 318 to block 314.

Block 314 shows installing the logical implication circuit in the machine learning model. As previously described, the manner of performing this installation depending on which way(s) each logical implication steering is being implemented. From block 314, control passes to block 322.

Block 322 represents a determination related to blocks 310 and 316; namely, whether to optimize for bₚ and/or a using the machine learning model. If so, control passes to block 324; otherwise, to block 328. Block 324 is performed if either or both of blocks 312 and 318 were not performed, or in implementation in which further optimization is to be performed using the machine learning model. Control passes from block 324 to block 328.

The flow is completed at block 328 and the logical implication steering will operate when the machine learning model is used for inference.

By way of more specific examples, some implementations extracting concept vectors p, q for concept-predicates P, Q, and builds a sub-network with these vectors which is inserted into the model. In this section, the following notation and conventions will be used. P, Q are used interchangeably to refer to high-level concepts, concept-predicates, and their corresponding sets, assuming without loss of generality that they belong to a global dataset distribution D. Following standard practices in mechanistic interpretability, concept representations are defined using hidden activations at the last token in some residual stream of the l-th transformer block. Concept vectors p, q are extracted from the input/output spaces of a linear operation, ensuring that, when substituting a LIMS circuit with a linear mapping (m-LIMS), it can be merged into the parameters of this operation.

In this example, the attention output projection map is selected (see FIG. 2), which linearly maps the concatenated attention head results into the residual stream. Let W be the output attention projection matrix at layer l, and let h(x) denote the model's partial computation mapping an input sequence x to the input space of W. The last token of x as x[−1] is denoted and vector operations are applied elementwise across sequences (e.g., Wh(x)). Let the mean hidden representation over a dataset S be:

$${m}_{S} = {𝔼}_{x ∈ S} ( h ( x ) [ - 1 ] ) \qquad ( 6 )$$

To implement LIMS, the datasets P, Q are specified that are within the domain D and that embody the desired concepts; their corresponding concept vectors p, q are extracted. Obtaining p and q can be done in any order or in parallel. While some implementations extract the concept vectors using linear probing, other techniques may be used (e.g., below is described a contrastive mean difference approach for simplicity and interpretability).

A concept vector for P is obtained as:

$${p}_{concept} = {m}_{P} - {m}_{¬ P} \qquad ( 7 )$$

Where ¬P: =D\P. To enhance signal strength and reduce variance of the mean, p_{concept} is refined by reducing ¬P to negative examples close to P; e.g., for a “happy” concept, ¬P could consist of minimal edits replacing happy words with unhappy ones. To ensure p aligns only with P and remains orthogonal elsewhere, the components aligned with ¬P are removed:

$$p = {p}_{concept} - {proj}_{m ¬ P} ( {p}_{concept} ) = {m}_{P} - {proj}_{m ¬ P} ( {m}_{P} ) . \qquad ( 8 )$$

Then p is normalized and the sensing circuit threshold bₚ set to be the maximum value of {p^{T} h(x)[−1]: x∈P} maximizing F1 score. Since p exists in a high-dimensional space, it remains approximately orthogonal to unrelated representations outside D, ensuring fₚ does not activate on unrelated tasks.

For steering into Q, assume ¬Q∩P≠Ø, otherwise P→Q holds trivially. The steering vector q is extracted to bring the mean state in ¬Q∩P to the mean state in Q:

$$q = {m}_{Q} - {m}_{¬ Q ⋂ P} \qquad ( 9 )$$

Given that behavior modifications should be limited to within P, for optimal steering and to minimize variance we replace m_{Q} with m_{Q∩P} in equation 9 when Q∩P≠Ø.

From these concept vectors the LIMS circuit f_{p,q} may be defined as the steering vector q modulated by the sensing perceptron fₚ, and the mergeable-LIMS circuit g_{q,p} may be defined by the outer product of the vectors:

$${f}_{q , p} ( x ) = q σ ( {p}^{T} h ( x ) - {b}_{p} ) . \qquad ( 10 )$$

$${g}_{q , p} ( x ) = {qp}^{T} h ( x ) . \qquad ( 11 )$$

m-LIMS relies on the model ignoring the small perturbation from adding εq, where |p^{T} h(x)|<ε off of P. Alternative implementations may use an additional variant for iterated merging.

LIMS or m-LIMS is incorporated into the model by adding the circuit to Wh(x):

$$W h ( x ) + {f}_{q , p} ( x ) , or \qquad ( 12 )$$

$$W h ( x ) + {g}_{q , p} ( \vert x ) = ( W + {qp}^{T} ) h ( x ) .$$

In the case of m-LIMS, replacing W with W+qp^{T} integrates the added circuit into the model's parameters. Concepts p and q are extracted concepts at the final token position, but note that the LIMS circuit operates as an architectural component of the transformer block which is applied at every token position. Notably, the similarity with p at preceding token positions rapidly diminishes in magnitude with distance from the last token and the LIMS circuit should not cause significant interference from earlier tokens.

Finally, q is scaled via α q with an additional hyperparameter α∈R⁺.

The above is summarized below:

Sequence datasets D, P, ¬P, Q, ¬Q, such that P ∩
¬P = Q ∩ ¬Q = ∅, and Wh(x) : D → ( [symbol] ⁿ)* a partial
transformer computation.
Extract concept vector p:
m_{P}, m_{¬P} ← [symbol] _{P}(h(x)[−1]), [symbol] _{¬P}(h(x)[−1])
p ← m_{P} − m_{¬P} − proj_{m¬}_{_{P}} (m_{P} − m_{¬P}₎
p ← p/||p||
Extract concept vector q:
m_{Q}, ← [symbol] _{Q}(Wh(x)[−1])
m_{¬Q∩P} ← [symbol] _{P∩(¬Q)}(Wh(x)[−1])
q ← m_{Q} − m_{¬Q∩P}
Optimize hyperparameters:
bₚ + argmax_{b}F1(σ(p^{T}h(x) − b), P(x))
α ← Optimize(α), q ← αq {See Alg. 2 in Appendix B.}
Replace Wh(x) function:
Wh(x) ← Wh(x) + qσ(p^{T}h(x) − bₚ)

Note that with LIMS there is the freedom to choose different concept representation spaces P and Q, as long as the space for Q is a descendant of the space for P in a directed acyclic graph of operations. This allows the use of LIMS to couple latent states across different models or even modalities. Also, LIMS circuits need not be implemented in parallel, and can be composed to better represent complex logical formulas.

With LIMS, as opposed to a traditionally opaque fine-tuning or prompting process, there is an interpretable circuit, which enables clearer evaluation of how the specific modifications affect model outputs, promoting transparency and precision, since one can model the evaluation accuracy as the product of independent random variables representing the classification accuracy for P, and the success accuracy of steering into Q.

By the nature of how p and q are extracted at the last token position of inputs in D, the LIMS circuit's effects are strongest at that position and diminish rapidly with distance from it. This allows for making predictions with a non-sequential decoupled statistical model using the last token-position as a proxy. Let Pr_{S}(Z) denote the probability of a boolean function Z(x)=1 on S⊆D, and recalling that Q_{Y}(x) is notation specifying that model Y generates behavior with concept Q on input x, let Q_{q}(x) denote whether steering with q at the last input token position only exhibits Q. Similarly, suppose fₚ here is the sensing circuit applied only at the final token position. The following may be observed: the probability of the approximate LIMS model behaving according to Q on S⊆D is:

$${Pr}_{S} ( \text{?} ) = {\underbrace{{Pr}_{S} ( {f}_{p} ) {Pr}_{S} ( {Q}_{q} \vert {f}_{p} )}}_{\begin{matrix}decoupled components of \\ LIMS circtui\end{matrix}} + {\underbrace{{Pr}_{S} ( {Q}_{Base} ⋀ ¬ {f}_{p} )}}_{{base model behaves withQ but}_{sensing predicts ¬ P}} \qquad ( 13 )$$

$$Where \text{?} is an approximate LIMS model with \\ circuit added at the last input token position only .$$

Due to the above identified approximate, the LIMS model is decoupled into contributions from its components at the last input token and those of the base model in exhibiting Q. Further, base model contributions on P are minimal, meaning the LIMS decoupled circuit components alone approximately capture P→Q. This allows analysis of each LIMS component to gain insight into the model's understanding, and to derive interpretable estimates of performance and risk.

Following is four separate question answering (QA) task that may be performed on a pre-trained Mistral 7B Instruct v0.2 model using the middle transformer block to add the LIMS circuits. To obtain datasets Q that represent correct model behavior on P, different approached may be used: 1) Base Behavior: Q consists of inputs where the base model behaves correctly on P, while ¬Q contains inputs where it behaves incorrectly; and 2) Prompted Behavior: Inputs in P are modified with additional instructions guiding the desired behavior to form Q, while unmodified inputs are assigned to Q. The following uses the Base Behavior approach.

The first QA task evaluates hallucination detection. The dataset P contains the hallucinated answers, while ¬P contains the same questions with their non-hallucinated answers. Thus, the basic LIMS circuit encodes “hallucination(x)→yes(x).” The second QA task evaluates hallucination reduction (that is, whether a model can correctly follow instruction to refrain from answering questions when provided with insufficient information). The dataset is split randomly by question topic, so that testing is done on separate topics, and accuracy and is measured by the model rejecting or not in the correct situation. P consists of questions with insufficient information context, and ¬P contains those with sufficient information context. The basic added LIMS circuit represents “insufficient info(x)→rejection(x).”

The third QA task evaluates model safety by challenging models with adversarially prompted harmful instructions. The adversarial attack prepends toxic prompts with: “ . . . <harmful instruction> Answer: Sure, I can do that for you:”. P is constructed from toxic prompts, while ¬P consists of harmless, identically structured prompts. The correct behavior Q on P is to reject harmful instructions, forming the LIMS circuit “toxic(x)→refusal(x).”

The fourth QA task evaluates activating chain-of-thought (COT) reasoning trajectories when faced with answering a mathematical problem. To create the LIMS circuit for this, math questions are aggregated to form P and ¬P. The set Q is formed with the prompting behavior extraction approach, where Q consists of examples in P with “Answer:” replaced with “Let's first think step by step in our answer. Answer:”, and ¬Q is the original math prompt. As such, LIMS is tasked with enabling a model to behave with chain-of thought generation when a math problem is sensed, following “math(x)→chain_of_thought(x)”.

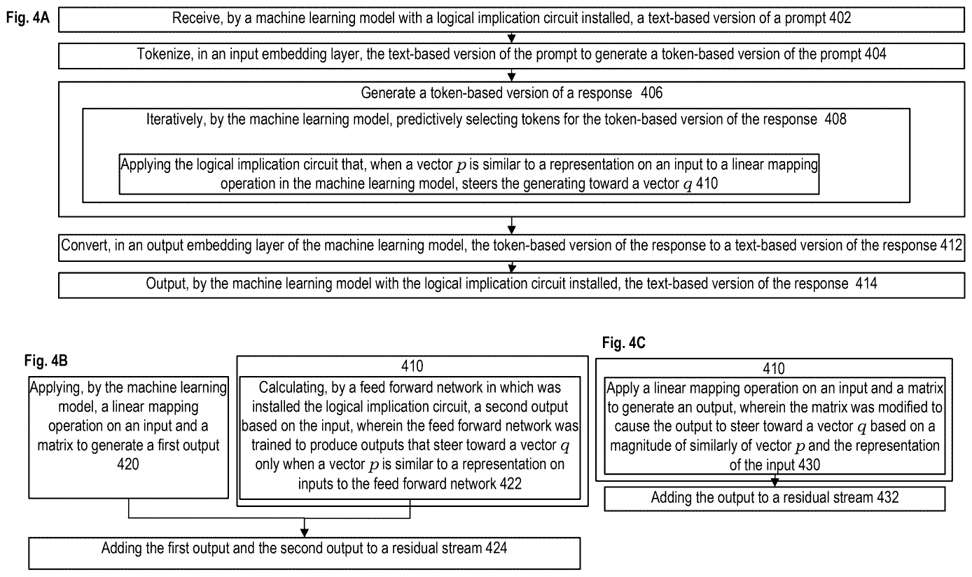

FIG. 4A is a flow diagram illustrating the use of a logical implication circuit installed within a machine learning model according to some implementations. Block 402 shows receiving, by machine learning model 110 with a logical implication circuit installed, a text-based version of a prompt.

In block 404, the input embedding layer 120 of the machine learning model tokenizes the text-based version of the prompt to generate a token-based version of the prompt.

At block 406, the machine learning model generates a token-based version of a response. Block 408, which is within block 406, shows that this generation involves iteratively predictively selecting tokens for the token-based version of the response.

Block 410, which is withing block 408, shows that the logical implication circuit is applied. This circuit steers the generative process toward a vector q when a vector p is similar to a representation on the input to a linear mapping operation within the model. Typically, the linear mapping operation is performed at least once on each of the iterations, and thus the logical implication circuit is applied at least one each iteration.

At block 412, the output embedding layer 122 of the machine learning model converts the token-based version of the response into a text-based version of the response. This conversion ensures the response is in a human-readable format.

Finally, in block 414, the machine learning model outputs the text-based version of the response. This response may be caused to be: 1) displayed on a screen; 2) converted to spoken audio and played for a user; 3) transmitted to another electronic device for either or both of the above.

FIG. 4B is a flow diagram illustrating the above described first way according to some implementations. The flow in FIG. 4B would be implemented each time the linear mapping operation is performed (e.g., on each iteration per block 408). At block 420, the machine learning model applies a linear mapping operation on an input and a matrix to generate a first output.

In block 422, a feed-forward network, which was installed as the logical implication circuit, calculates a second output based on the input. This network was trained to produce outputs that steer toward a vector q only when a vector p is similar to a representation on inputs to the feed-forward network. Thus, block 422 is a way of performing block 410.

From blocks 420 and 422, control passes to block 424. Block 424 shows adding the first output and the second output to a residual stream. Depending on the implementation, block 424 may also be viewed as being part of block 410.

FIG. 4C is a flow diagram illustrating the above described second way according to some implementations. The flow in FIG. 4C would be implemented each time the linear mapping operation is performed (e.g., on each iteration per block 408). At block 430, the machine learning model applies a linear mapping operation on an input and a matrix to generate an output. This matrix was modified to cause the output to steer toward a vector q based on the magnitude of similarity of vector p and the representation of the input. Thus, block 422 is a way of performing block 410. From block 430, control passes to block 432.

In block 432, the output generated by the linear mapping operation is added to a residual stream. Depending on the implementation, block 432 may also be viewed as being part of block 410.

In implementations in which both the first and second ways are implemented in conjunction with a linear mapping operation, block 420 would be replaced with block 430 in FIG. 4B.

In summary, LIMS is a logically grounded approach for integrating neuro-symbolic concept-reasoning into pretrained transformer-based machine learning models through a conditional circuit. LIMS provides a structured mechanism for conditionally steering model behavior, enabling interpretable contextual control of model outputs. LIMS is highly compute and data-efficient, can operate using a relatively low number of labeled examples and activations from model inference to induce relatively large performance shifts. This efficiency makes LIMS well-suited for real-world deployment, particularly in settings with limited labeled data or rare failure cases such as hallucinations.

Thus, in some implementations, LIMS operates by interpreting activations through a formal predicate logic defined on hidden states of some model. In this logic, variables are represented by input contexts, and predicates are defined relative to a model as binary random variables of (unrolled trajectories) of hidden states of this model. These random predicates on hidden states define binary random variables on the input space via composition with the model. The fuzzy truth value of a predicate on an input is then determined as a probability of whether this input is a member of the predicate's representative set when unrolled through the model. In practice representative data is used to define the concept predicates. For example, a predicate cat can be defined as representing sensing of the concept of cats in the text context, by the distribution of activations of some layer of a pre-trained LLM on the last token of all random texts containing the word “cat.” Whether cat (x) is true on a given input text x can be classified based on the representational similarity of the hidden state to the cat distribution. Note that this implicitly defines ¬cat, the negation of cat, as data where the predicate is false. Instead, cat could be defined to be the distribution of layer activations over the last token all texts which cause generation of text containing the word “cat.” The distinction between model states which sense something about a context, and states which lead to a certain generation behavior, is used since the goal is to steer generation based on sensing a given concept.

Assume the model is to role play as a talking dog whenever the cat variable is (classified to be) true in an input context. That is to say, the model should satisfy the implication “cat(x)→behave_dog(x),” where behave_dog is a predicate defined by the distribution of hidden states that elicit model generation to role play as talking a dog. The model states sensing cat are coupled with the generation results typical of the states in behave_dog. While this may seem trivial to achieve via prompting, models often struggle with in-context learning of such conditional behavior in practical scenarios. This can occur since states which sense something specific may not be coupled to feed forward to states in the model which cause the desired generation behavior. Furthermore, even fine-tuning may fail to enforce this behavior because it cannot reliably train new internal logic or circuits that were not already present in the model's pre-training. With the LIMS method, cat(x)→behave_dog(x) may be built into the model generation behavior. Recall that negation and implication are complete for propositional logic, and that since our method is capable of negating formulas with the feed-forward circuit produced from P→¬P, any quantifier free formula may be theoretically represented with successive applications and combinations of LIMS.

### Example Electronic Devices and Environments

The above-described artificial intelligence (AI) technology may be included as part of a network or system comprising a hardware- or software-based framework for training, processing, fine-tuning, or performing any other implementation steps. Furthermore, the AI technology may include a hardware- or software-based framework that performs one or more functions, such as retrieving, generating, accessing, transmitting, etc.

Moreover, the AI technology may be trained or fine-tuned using supervised, unsupervised, or other AI training techniques. In various implementations, the AI technology may be trained or fine-tuned using a set of general datasets or a set of datasets directed to a particular field or task. Additionally or alternatively, the AI technology may be intermittently updated at a set interval or in real time based on resulting output or additional data to further train the AI technology. Furthermore, the AI technology may implement Retrieval-Augmented Generation (RAG) or other techniques after training or fine-tuning by accessing a set of documents or knowledge base directed to a particular field or website other than the training or fine-tuning data to influence the AI technology's output with the set of documents or knowledge base.

To further guide and train output of the AI technology, a plurality of input prompts may be provided to the AI technology for the purpose of eliciting particular responses. In various implementations, the plurality of input prompts may correspond to the particular field or task to which the AI technology is trained. Additionally, the AI technology may be implemented along with a plurality of additional AI technologies. For example, a first AI model may produce a first output, which is used as input for a second AI model to produce a second output. These AI technologies may be used in succession of one another, in parallel with another, or a combination of both. Furthermore, the AI technologies may be merged in a variety of implementations, for example, by bagging, boosting, stacking, etc. the AI technologies.

The tokenizing may also include applying any preprocessing techniques, such as stemming, lemmatization, normalization, punctuation removal, masking, hashing, encoding, or any combination thereof. In some implementations, after tokenization (or as part of tokenization), grouping of words can be done to identify specific phrases or entities that are relevant to the task.

### Electronic Device and Machine-Readable Media

One or more parts of the above implementations may include software. Software is a general term whose meaning can range from part of the code and/or metadata of a single computer program to the entirety of multiple programs. A computer program (also referred to as a program) comprises code and optionally data. Code (sometimes referred to as computer program code or program code) comprises software instructions (also referred to as instructions). Instructions may be executed by hardware to perform operations. Executing software includes executing code, which includes executing instructions. The execution of a program to perform a task involves executing some or all of the instructions in that program.

An electronic device (also referred to as a device, computing device, computer, machine, etc.) includes hardware and software. For example, an electronic device may include a set of one or more processors coupled to one or more machine-readable storage media (e.g., non-volatile memory such as magnetic disks, optical disks, read only memory (ROM), Flash memory, phase change memory, solid state drives (SSDs)) to store code and optionally data. For instance, an electronic device may include non-volatile memory (with slower read/write times) and volatile memory (e.g., dynamic random-access memory (DRAM), static random-access memory (SRAM)). Non-volatile memory persists code/data even when the electronic device is turned off or when power is otherwise removed, and the electronic device copies that part of the code that is to be executed by the set of processors of that electronic device from the non-volatile memory into the volatile memory of that electronic device during operation because volatile memory typically has faster read/write times. As another example, an electronic device may include a non-volatile memory (e.g., phase change memory) that persists code/data when the electronic device has power removed, and that has sufficiently fast read/write times such that, rather than copying the part of the code to be executed into volatile memory, the code/data may be provided directly to the set of processors (e.g., loaded into a cache of the set of processors). In other words, this non-volatile memory operates as both long term storage and main memory, and thus the electronic device may have no or only a small amount of volatile memory for main memory.

In addition to storing code and/or data on machine-readable storage media, typical electronic devices can transmit and/or receive code and/or data over one or more machine-readable transmission media (also called a carrier) (e.g., electrical, optical, radio, acoustical or other forms of propagated signals—such as carrier waves, and/or infrared signals). For instance, typical electronic devices also include a set of one or more physical network interface(s) to establish network connections (to transmit and/or receive code and/or data using propagated signals) with other electronic devices. Thus, an electronic device may store and transmit (internally and/or with other electronic devices over a network) code and/or data with one or more machine-readable media (also referred to as computer-readable media).

Software instructions (also referred to as instructions) are capable of causing (also referred to as operable to cause and configurable to cause) a set of processors to perform operations when the instructions are executed by the set of processors. The phrase “capable of causing” (and synonyms mentioned above) includes various scenarios (or combinations thereof), such as instructions that are always executed versus instructions that may be executed. For example, instructions may be executed: 1) only in certain situations when the larger program is executed (e.g., a condition is fulfilled in the larger program; an event occurs such as a software or hardware interrupt, user input (e.g., a keystroke, a mouse-click, a voice command); a message is published, etc.); or 2) when the instructions are called by another program or part thereof (whether or not executed in the same or a different process, thread, lightweight thread, etc.). These scenarios may or may not require that a larger program, of which the instructions are a part, be currently configured to use those instructions (e.g., may or may not require that a user enables a feature, the feature or instructions be unlocked or enabled, the larger program is configured using data and the program's inherent functionality, etc.). As shown by these exemplary scenarios, “capable of causing” (and synonyms mentioned above) does not require “causing” but the mere capability to cause. While the term “instructions” may be used to refer to the instructions that when executed cause the performance of the operations described herein, the term may or may not also refer to other instructions that a program may include. Thus, instructions, code, program, and software are capable of causing operations when executed, whether the operations are always performed or sometimes performed (e.g., in the scenarios described previously). The phrase “the instructions when executed” refers to at least the instructions that when executed cause the performance of the operations described herein but may or may not refer to the execution of the other instructions.

Electronic devices are designed for and/or used for a variety of purposes, and different terms may reflect those purposes (e.g., user devices, network devices). Some user devices are designed to mainly be operated as servers (sometimes referred to as server devices), while others are designed to mainly be operated as clients (sometimes referred to as client devices, client computing devices, client computers, or end user devices; examples of which include desktops, workstations, laptops, personal digital assistants, smartphones, wearables, augmented reality (AR) devices, virtual reality (VR) devices, mixed reality (MR) devices, etc.). The software executed to operate a user device (typically a server device) as a server may be referred to as server software or server code), while the software executed to operate a user device (typically a client device) as a client may be referred to as client software or client code. A server provides one or more services to one or more clients.

The above-described machine learning model 110 may be implemented: 1) on each of one or more client devices; and/or 2) on one or more server devices. In some implementations, the machine learning model 110 may be implemented on one or more service devices as a service (sometimes referred to as an AI service) or as part of a service (sometimes referred to as an AI augmented service), which service is provided to other services and/or to one or more client devices. Similarly, some or all of logical implication detection and steering generator 180 may be implemented on a client device and/or on a server device. For example, blocks 184, 186, and 188 may be implemented on a client device (or a first server device), and then the logical implication circuit installed in machine learning model 110 implemented on a server device (e.g., the same first server device or a different server device) before block 190 is performed using machine learning model 110.

The term “user” refers to an entity (e.g., an individual person) that uses an electronic device. Software and/or services may use credentials to distinguish different accounts associated with the same and/or different users. Users can have one or more roles, such as administrator, programmer/developer, and end user roles. As an administrator, a user typically uses electronic devices to administer them for other users, and thus an administrator often works directly and/or indirectly with server devices and client devices.

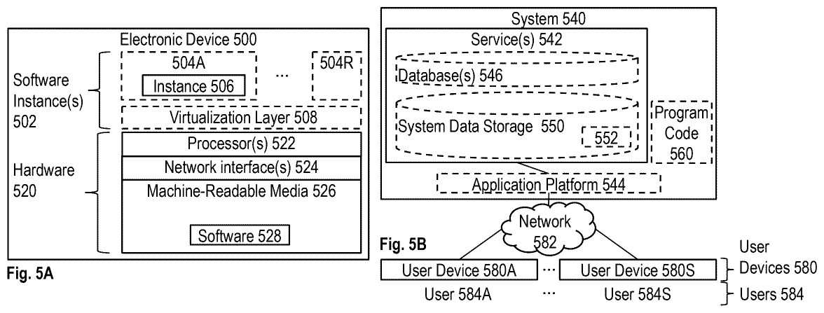

FIG. 5A is a block diagram illustrating an electronic device 500 according to some example implementations. FIG. 5A includes hardware 520 comprising a set of one or more processor(s) 522, a set of one or more network interfaces 524 (wireless and/or wired), and machine-readable media 526 having stored therein software 528 (which includes instructions executable by the set of one or more processor(s) 522). The machine-readable media 526 may include non-transitory and/or transitory machine-readable media. Each of the previously described clients and a specific service (the AI service or an AI augmented service) may be implemented in one or more of electronic device 500. In one implementation: 1) each of the clients is implemented in a separate one of the electronic device 500 (e.g., in end user devices where the software 528 represents the software to implement clients to interface directly and/or indirectly with the specific service (e.g., software 528 represents a web browser, a native client, a portal, a command-line interface, and/or an application programming interface (API) based upon protocols such as Simple Object Access Protocol (SOAP), Representational State Transfer (REST), etc.)); 2) the specific service is implemented in a separate set of one or more of electronic device 500 (e.g., a set of one or more server devices where the software 528 represents the software to implement the specific service); and 3) in operation, the electronic devices implementing the clients and the specific service would be communicatively coupled (e.g., by a network) and would establish between them (or through one or more other layers and/or or other services) connections for submitting prompts to the specific service (and thus machine learning model 110) and returning responses to the clients (e.g., for display to a user, for playback of spoken audio generated from the response to a user, both). Other configurations of electronic devices may be used in other implementations (e.g., an implementation in which the client and the specific service are implemented on a single one of electronic device 500).

During operation, an instance of the software 528 (illustrated as instance 506 and referred to as a software instance; and in the more specific case of an application, as an application instance) is executed. In electronic devices that use compute virtualization, the set of one or more processor(s) 522 typically execute software to instantiate a virtualization layer 508 and a set of one or more software containers, shown as software container 504A to software container 504R (e.g., with operating system-level virtualization, the virtualization layer 508 may represent a container engine (such as Docker® Engine container runtime by Docker, Inc. or Red Hat® OpenShift container runtime by Red Hat, Inc.) running on top of (or integrated into) an operating system, and it allows for the creation of multiple software containers (representing separate user space instances and also called virtualization engines, virtual private servers, or jails) that may each be used to execute a set of one or more applications; with full virtualization, the virtualization layer 508 represents a hypervisor (sometimes referred to as a virtual machine monitor (VMM)) or a hypervisor executing on top of a host operating system, and the software containers each represent a tightly isolated form of a software container called a virtual machine that is run by the hypervisor and may include a guest operating system; with para-virtualization, an operating system and/or application running with a virtual machine may be aware of the presence of virtualization for optimization purposes). Again, in electronic devices where compute virtualization is used, during operation, an instance of the software 528 is executed within the software container 504A on the virtualization layer 508. In electronic devices where compute virtualization is not used, the instance 506 on top of a host operating system is executed on the “bare metal” electronic device 500. Instances of the software 528, as well as the virtualization layer 508 and the software containers if implemented, are collectively referred to as software instance(s) 502.

Alternative implementations of an electronic device may have numerous variations from that described above. For example, customized hardware and/or accelerators might also be used in an electronic device.

### Example Environment

FIG. 5B is a block diagram of a deployment environment according to some example implementations. A system 540 includes hardware (e.g., a set of one or more server devices) and software to provide service(s) 542, including the above-described specific service (an AI service or an AI augmented service). In some implementations the system 540 is in one or more datacenter(s). These datacenter(s) may be: 1) first party datacenter(s), which are datacenter(s) owned and/or operated by the same entity that provides and/or operates some or all of the software that provides the service(s) 542; and/or 2) third-party datacenter(s), which are datacenter(s) owned and/or operated by one or more different entities than the entity that provides the service(s) 542 (e.g., the different entities may host some or all of the software provided and/or operated by the entity that provides the service(s) 542). For example, third-party datacenters may be owned and/or operated by entities providing public cloud services (e.g., Amazon Web Services® service by Amazon.com, Inc., Google Cloud Platform™ service by Google LLC, Azure® service by Microsoft Corporation).

The system 540 is coupled to user devices 580 (shown as user device 580A to user device 580S) over a network 582. The service(s) 542 may be on-demand services that are made available to users 584 (shown as user 584A to user 584S) working for one or more entities other than the entity which owns and/or operates the on-demand services (those users sometimes referred to as outside users) so that those entities need not be concerned with building and/or maintaining a system, but instead may make use of the service(s) 542 when needed (e.g., when needed by the users). The service(s) 542 may communicate with each other and/or with one or more of the user devices 580 via one or more APIs (e.g., a REST API). In some implementations, the user devices 580 are operated by the users 584, and each may be operated as a client device and/or a server device. In some implementations, one or more of the user devices 580 are separate ones of the electronic device 500 or include one or more features of the electronic device 500.

In some implementations, the system 540 is a multi-tenant system (also known as a multi-tenant architecture). The term multi-tenant system refers to a system in which various elements of hardware and/or software of the system may be shared by one or more tenants. A multi-tenant system may be operated by a first entity (sometimes referred to a multi-tenant system provider, operator, or vendor; or simply a provider, operator, or vendor) that provides one or more services to the tenants (in which case the tenants are customers of the operator and sometimes referred to as operator customers). A tenant typically includes a group of users with access to at least some of the same data/functionality with the same or similar privileges/permissions. Tenants may be different entities (e.g., different companies, different departments/divisions of a company, and/or other types of entities), and some or all these entities may be vendors that sell or otherwise provide products and/or services to their customers (sometimes referred to as tenant customers). A multi-tenant system may allow each tenant to input tenant specific data for user management, tenant-specific functionality, configuration, customizations, non-functional properties, associated applications, etc. A tenant may have one or more roles relative to a system and/or service. For example, in the context of a customer relationship management (CRM) system or service, a tenant may be a vendor using the CRM system or service to manage information the tenant has regarding one or more customers of the vendor. As another example, in the context of Data as a Service (DAAS), one set of tenants may be vendors providing data and another set of tenants may be customers of different ones or all the vendors' data. As another example, in the context of Platform as a Service (PAAS), one set of tenants may be third-party application developers providing applications/services and another set of tenants may be customers of different ones or all the third-party application developers.

Multi-tenancy can be implemented in different ways. In some implementations, a multi-tenant architecture may include software instance(s) that are shared by multiple tenants (e.g., a single database instance share by multiple tenants, sometime referred to as a multi-tenant database; a single application instance shared by multiple tenants, sometimes referred to as a multi-tenant application; a single application instance and a single database instance shared by multiple tenants; an application instance per tenant and a database instance shared by multiple tenants; a single application instance share by multiple tenants and a database instance per tenant).

In one implementation, the system 540 is a multi-tenant cloud computing architecture supporting multiple services, including the above-described AI service and/or one or more of the following types of services (some or all of which may use the AI service or themselves be an augmented AI service): Customer relationship management (CRM); Configure, price, quote (CPQ); Business process modeling (BPM); Customer support; Marketing; External data connectivity; Productivity; Database-as-a-Service; Data-as-a-Service (DAAS or DaaS); Platform-as-a-service (PAAS or PaaS); Infrastructure-as-a-Service (IAAS or IaaS) (e.g., virtual machines, servers, and/or storage); Analytics; Community; Internet-of-Things (IoT); Industry-specific; Application marketplace (“app store”); Data modeling; Security; and Identity and access management (IAM).

For example, system 540 may include an application platform 544 that enables PAAS for creating, managing, and executing one or more applications developed by the provider of the application platform 544, users accessing the system 540 via one or more of the user devices 580, or third-party application developers accessing the system 540 via one or more of user devices 580.

In some implementations, one or more of the service(s) 542 may use one or more database(s) 546 and/or system data storage 550 (which stores system data 552). In certain implementations, the system 540 includes a set of one or more servers that are running on server electronic devices and that are configured to handle requests for any authorized user associated with any tenant (there is no server affinity for a user and/or tenant to a specific server). The user devices 580 communicate with the server(s) of system 540 to request and update tenant-level data and system-level data hosted by system 540, and in response the system 540 (e.g., one or more servers in system 540) automatically may generate one or more Structured Query Language (SQL) statements (e.g., one or more SQL queries) that are designed to access the desired information from the database(s) 546 and/or system data storage 550.

In some implementations, the service(s) 542 are implemented using virtual applications dynamically created at run time responsive to queries from the user devices 580 and in accordance with metadata, including: 1) metadata that describes constructs (e.g., forms, reports, workflows, user access privileges, business logic) that are common to multiple tenants; and/or 2) metadata that is tenant specific and describes tenant specific constructs (e.g., tables, reports, dashboards, interfaces, etc.) and is stored in a multi-tenant database. To that end, the program code 560 may be a runtime engine that materializes application data from the metadata; that is, there is a clear separation of the compiled runtime engine (also known as the system kernel), tenant data, and the metadata, which makes it possible to independently update the system kernel and tenant-specific applications and schemas, with virtually no risk of one affecting the others. Further, in one implementation, the application platform 544 includes an application setup mechanism that supports application developers' creation and management of applications, which may be saved as metadata by save routines. Invocations to such applications, including the above-described specific service (an AI service and/or an AI augmented service), may be coded using Procedural Language/Structured Object Query Language (PL/SOQL) that provides a programming language style interface. Invocations to applications may be detected by one or more system processes, which manages retrieving application metadata for the tenant making the invocation and executing the metadata as an application in a software container (e.g., a virtual machine).

Network 582 may be any one or any combination of a LAN (local area network), WAN (wide area network), telephone network, wireless network, point-to-point network, star network, token ring network, hub network, or other appropriate configuration. The network may comply with one or more network protocols, including an Institute of Electrical and Electronics Engineers (IEEE) protocol, a 3rd Generation Partnership Project (3GPP) protocol, a 4^{th} generation wireless protocol (4G) (e.g., the Long Term Evolution (LTE) standard, LTE Advanced, LTE Advanced Pro), a fifth generation wireless protocol (5G), and/or similar wired and/or wireless protocols, and may include one or more intermediary devices for routing data between the system 540 and the user devices 580.

Each of the user devices 580 (such as a desktop personal computer, workstation, laptop, Personal Digital Assistant (PDA), smartphone, smartwatch, wearable device, augmented reality (AR) device, virtual reality (VR) device, etc.) typically includes one or more user interface devices, such as a keyboard, a mouse, a trackball, a touch pad, a touch screen, a pen or the like, video or touch free user interfaces, for interacting with a graphical user interface (GUI) provided on a display (e.g., a monitor screen, a liquid crystal display (LCD), a head-up display, a head-mounted display, etc.) in conjunction with pages, forms, applications and other information provided by system 540. For example, the user interface device can be used to access data and applications hosted by system 540, and to perform searches on stored data, and otherwise allow one or more of users 584 to interact with various GUI pages that may be presented to the one or more of users 584. The user devices 580 may communicate with system 540 using TCP/IP (Transfer Control Protocol and Internet Protocol) and, at a higher network level, use other networking protocols to communicate, such as Hypertext Transfer Protocol (HTTP), File Transfer Protocol (FTP), Andrew File System (AFS), Wireless Application Protocol (WAP), Network File System (NFS), an application program interface (API) based upon protocols such as Simple Object Access Protocol (SOAP), Representational State Transfer (REST), etc. In an example where HTTP is used, one or more the user devices 580 may include an HTTP client, commonly referred to as a “browser,” for sending and receiving HTTP messages to and from server(s) of system 540, thus allowing one or more of the users 584 to access, process and view information, pages and applications available from system 540 over network 582.

### CONCLUSION

In the above description, numerous specific details such as resource partitioning/sharing/duplication implementations, types and interrelationships of system components, and logic partitioning/integration choices are set forth in order to provide a more thorough understanding. The invention may be practiced without such specific details, however. In other instances, control structures, logic implementations, opcodes, means to specify operands, and full software instruction sequences have not been shown in detail since those of ordinary skill in the art, with the included descriptions, will be able to implement what is described without undue experimentation.

References in the specification to “one implementation,” “an implementation,” “an example implementation,” etc., indicate that the implementation described may include a particular feature, structure, or characteristic, but every implementation may not necessarily include the particular feature, structure, or characteristic. Moreover, such phrases are not necessarily referring to the same implementation. Further, when a particular feature, structure, and/or characteristic is described in connection with an implementation, one skilled in the art would know to affect such feature, structure, and/or characteristic in connection with other implementations whether or not explicitly described.

For example, the figure(s) illustrating flow diagrams sometimes refer to the figure(s) illustrating block diagrams, and vice versa. Whether or not explicitly described, the alternative implementations discussed with reference to the figure(s) illustrating block diagrams also apply to the implementations discussed with reference to the figure(s) illustrating flow diagrams, and vice versa. At the same time, the scope of this description includes implementations, other than those discussed with reference to the block diagrams, for performing the flow diagrams, and vice versa.

Bracketed text and blocks with dashed borders (e.g., large dashes, small dashes, dot-dash, and dots) may be used herein to illustrate optional operations and/or structures that add additional features to some implementations. However, such notation should not be taken to mean that these are the only options or optional operations, and/or that blocks with solid borders are not optional in certain implementations.

The detailed description and claims may use the term “coupled,” along with its derivatives. “Coupled” is used to indicate that two or more elements, which may or may not be in direct physical or electrical contact with each other, co-operate or interact with each other.

While the flow diagrams in the figures show a particular order of operations performed by certain implementations, such order is exemplary and not limiting (e.g., alternative implementations may perform the operations in a different order, combine certain operations, perform certain operations in parallel, overlap performance of certain operations such that they are partially in parallel, etc.).

What is claimed is:

1. A method comprising:
receiving, by a machine learning model with a logical implication circuit installed, a text-based version of a prompt;
tokenizing, in an input embedding layer of the machine learning model, the text-based version of the prompt to generate a token-based version of the prompt;
generating a token-based version of a response based on the token-based version of the prompt, the generating comprising:
iteratively, by the machine learning model, predictively selecting tokens for the token-based version of the response, wherein the iteratively predictively selecting tokens comprises:
applying the logical implication circuit that, when a first vector is similar to a representation on an input to a linear mapping operation in the machine learning model, steers the generating toward a second vector;
converting, in an output embedding layer of the machine learning model, the token-based version of the response to a text-based version of the response, and
outputting, by the machine learning model, the text-based version of the response.

2. The method of claim 1, wherein:
the iteratively predictively selecting tokens comprises:
applying, by the machine learning model, the linear mapping operation on the input and a matrix to generate a first output;
the applying the logical implication circuit comprises:
calculating, by a feed forward network installed as the logical implication circuit in the machine learning model, a second output based on the input, wherein the feed forward network was trained to produce outputs that steer toward the second vector only when the first vector is similar to a representation on inputs to the feed forward network; and
the method further comprises:
adding the first output and the second output to a residual stream.

3. The method of claim 1, wherein:
the applying the logical implication circuit comprises:
applying, by the machine learning model, the linear mapping operation to the input and a matrix to generate an output, wherein the matrix was modified to cause the output to steer toward the second vector based on a magnitude of similarly of the first vector and the representation on the input to the linear mapping operation; and
the method further comprises:
adding the output to a residual stream.

4. The method of claim 1, wherein the linear mapping operation is in an attention layer of the machine learning model.

5. The method of claim 4, wherein the attention layer is part of a first of a plurality of blocks of the machine learning model, wherein the plurality of blocks is between the input embedding layer and the output embedding layer.

6. The method of claim 5, wherein the plurality of blocks are in an order, and wherein at least one quarter of the plurality of blocks come before the first of the plurality of blocks.

7. The method of claim 4, wherein the attention layer is a multi-head attention layer, and the linear mapping operation is on the input and an output attention project matrix.

8. The method of claim 1, wherein the first vector was extracted from a first predicate, and wherein the second vector was extracted from a second predicate.

9. The method of claim 1, wherein the second vector is scaled with an optimized hyperparameter.

10. The method of claim 1, wherein the logical implication circuit reduces hallucinations even when trained using less than or equal to 100 training data points.

11. A non-transitory machine-readable storage medium that provides instructions that, if executed by one or any combination of a set of processors, are configurable to cause a system to perform operations comprising:
receiving, by a machine learning model with a logical implication circuit installed, a text-based version of a prompt;
tokenizing, in an input embedding layer of the machine learning model, the text-based version of the prompt to generate a token-based version of the prompt;
generating a token-based version of a response based on the token-based version of the prompt, the generating comprising:
iteratively, by the machine learning model, predictively selecting tokens for the token-based version of the response, wherein the iteratively predictively selecting tokens comprises:
applying the logical implication circuit that, when a first vector is similar to a representation on an input to a linear mapping operation in the machine learning model, steers the generating toward a second vector;
converting, in an output embedding layer of the machine learning model, the token-based version of the response to a text-based version of the response, and
outputting, by the machine learning model, the text-based version of the response.

12. The non-transitory machine-readable storage medium of claim 11, wherein:
the iteratively predictively selecting tokens comprises:
applying, by the machine learning model, the linear mapping operation on the input and a matrix to generate a first output;
the applying the logical implication circuit comprises:
calculating, by a feed forward network installed as the logical implication circuit in the machine learning model, a second output based on the input, wherein the feed forward network was trained to produce outputs that steer toward the second vector only when the first vector is similar to a representation on inputs to the feed forward network; and
the method further comprises:
adding the first output and the second output to a residual stream.

13. The non-transitory machine-readable storage medium of claim 11, wherein:
the applying the logical implication circuit comprises:
applying, by the machine learning model, the linear mapping operation to the input and a matrix to generate an output, wherein the matrix was modified to cause the output to steer toward the second vector based on a magnitude of similarly of the first vector and the representation on the input to the linear mapping operation; and
the method further comprises:
adding the output to a residual stream.

14. The non-transitory machine-readable storage medium of claim 11, wherein the linear mapping operation is in an attention layer of the machine learning model.

15. The non-transitory machine-readable storage medium of claim 14, wherein the attention layer is part of a first of a plurality of blocks of the machine learning model, wherein the plurality of blocks is between the input embedding layer and the output embedding layer.

16. The non-transitory machine-readable storage medium of claim 15, wherein the plurality of blocks are in an order, and wherein at least one quarter of the plurality of blocks come before the first of the plurality of blocks.

17. The non-transitory machine-readable storage medium of claim 14, wherein the attention layer is a multi-head attention layer, and the linear mapping operation is on the input and an output attention project matrix.

18. The non-transitory machine-readable storage medium of claim 11, wherein the first vector was extracted from a first predicate, and wherein the second vector was extracted from a second predicate.

19. The non-transitory machine-readable storage medium of claim 11, wherein the second vector is scaled with an optimized hyperparameter.

20. The non-transitory machine-readable storage medium of claim 11, wherein the logical implication circuit reduces hallucinations even when trained using less than or equal to 100 training data points.
